(19) United States
(12) Patent Application Publication
(10) Pub. No.: US 2024/0028346 A1
(43) Pub. Date: Jan. 25, 2024

(54) LINKING KUBERNETES RESOURCES WITH UNDERLYING CLOUD INFRASTRUCTURE

(71) Applicant: VMware, Inc., Palo Alto, CA (US)

(72) Inventors: Ankit Khani, Bellevue, WA (US); Nandesh Amit Guru, Bellevue, WA (US); Deep Pradeep Desai, Bellevue, WA (US)

(21) Appl. No.: 17/871,126

(22) Filed: Jul. 22, 2022

(51) Int. Cl. G06F 9/445; G06F 9/50

(52) U.S. Cl. CPC G06F 9/44505; G06F 9/5077

(57) ABSTRACT

Systems and methods are described for linking Kubernetes resources with underlying infrastructure. An agent running in a Kubernetes cluster can collect data about the cluster. The agent can add universal identifiers (“UIDs”) corresponding to specific characteristics of the Kubernetes cluster. The agent can send the data with the UIDs to a backend service. The backend service can identify a cluster on a host platform that corresponds to the Kubernetes cluster based on the UIDs. The backend service can then link components of the Kubernetes cluster to host machines in the host platform that they are running on. Using the links, a graph model can be displayed in a graphical user interface. The graph model can visually illustrate how the components in the Kubernetes cluster and the host cluster connect to each other.

### BACKGROUND

Kubernetes has become the common tool for container orchestration in the cloud today. Kubernetes systems deploy containerized applications on top of a host platform using a cluster-based architecture. The extensibility and customizability of Kubernetes has resulted in its rapid adoption in building complex information technology (“IT”) systems.

One problem with Kubernetes systems is that they increase the attack surface on the systems running them. Kubernetes resources either run on or provide an abstraction on top of underlying cloud resources. Because of this, a security violation on a Kubernetes resource allows an attacker to compromise underlying cloud resources, and vice versa. Traditional cloud security products look at Kubernetes and cloud systems in isolation and do not provide a layered, connected view of cloud resources along with their Kubernetes counterparts. This makes it difficult to gauge the true security posture of complex IT systems running on Kubernetes and in the cloud. It is also difficult to analyze the chain of violation from a cloud resource to Kubernetes, and vice versa.

As a result, a need exists for providing a layered, connected view of cloud resources along with their Kubernetes counterparts.

### SUMMARY

Examples described herein include systems and methods for linking Kubernetes resources with underlying infrastructure. In an example, a backend service can receive snapshot data relating to the state of host clusters running on a host platform. The host clusters can include host machines that Kubernetes clusters run on. The host machines can be any kind of computing device, physical or virtual, that can host Kubernetes components. The host snapshot data can include information unique to each host cluster, such as the provider of the host platform, an account holder, a Kubernetes namespace, and a geographic region where the host machines run. The backend service can translate the host snapshot data according to a database schema where each component of the host clusters has an entry with relevant information, including the unique characteristics.

An agent associated with the backend service can run on each Kubernetes cluster. The agent can retrieve and send snapshot data for the Kubernetes cluster to the backend service. The Kubernetes snapshot data can include data about components of the Kubernetes cluster. The agent can be configured to add information specific to the Kubernetes cluster that is not provided by the Kubernetes cluster. This information can correspond to the corresponding host cluster. In one example, the agent can add this information as universal identifiers (“UIDs”). For example, each characteristic can have a UID designated by the backend service. Each agent can be preconfigured with a combination of UIDs corresponding to characteristics specific to the host cluster that the agent's Kubernetes cluster is running on. The agent can add the UIDs to the Kubernetes snapshot data before sending the Kubernetes snapshot data to the backend service.

The backend service can identify the host snapshot data that corresponds to the Kubernetes snapshot data using the UIDs. For example, the backend service can match the UIDs to the host cluster with matching characteristics. Once the correct host cluster has been identified, the backend service can translate the Kubernetes snapshot data according to the database schema and link entries for Kubernetes components to their corresponding host machines. The backend service can also link Kubernetes components with other related Kubernetes components. For example, the backend service can create an entry for each Kubernetes component and insert deep links that links the component to other components in the host and Kubernetes clusters based on the host and Kubernetes snapshot data.

The backend service can generate a graph model of the Kubernetes cluster that visually links all the components related to the cluster. For example, each component can have a graph node that is connected to other graph nodes using edges, and the configuration can be based on the links. The graph model can therefore depict the configuration of a Kubernetes cluster including the host machines hosting the Kubernetes cluster. In other words, the graph model can show what Kubernetes resources are connected to each other and what host machine each Kubernetes resource is running on. If, for example, a Kubernetes or host component is misconfigured or presents a security risk, a user can view the graph model to see what other components may be affected and how far the risk can reach within a system.

The backend service can update the links and the graph model based on changes that occur at the Kubernetes cluster and the host cluster. For example, the agent can periodically request updates from the Kubernetes cluster. When an update to a Kubernetes component occurs, such as a component being added or removed, the agent can add the UIDs of the Kubernetes cluster and send the update data to the backend service. The backend service can then verify the change with the host cluster. For example, the backend service can send a request to the host platform for status information on the host machine that the changed component is running on. If the response from the host cluster confirms the change, then the backend service can update the data and deep links for the Kubernetes cluster.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example system for linking Kubernetes resources with underlying infrastructure.

FIG. 2 is a flowchart of an example method for linking Kubernetes resources with underlying infrastructure.

FIG. 3 is a sequence diagram of an example method for linking Kubernetes resources with underlying infrastructure.

FIG. 4 is another flowchart of an example method for updating Kubernetes resource links with underlying infrastructure.

FIG. 5 is another sequence diagram of an example method for updating Kubernetes resource links with underlying infrastructure.

FIG. 6 is an illustration of an example graphical user interface (“GUI”) of Kubernetes resource linked with underlying infrastructure.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for linking Kubernetes resources with underlying infrastructure. An agent running in a Kubernetes cluster can collect data about the cluster. The agent can add universal identifiers (“UIDs”) corresponding to specific characteristics of the Kubernetes cluster. The agent can send the data with the UIDs to a backend service. The backend service can identify a cluster on a host platform that corresponds to the Kubernetes cluster based on the UIDs. The backend service can then link components of the Kubernetes cluster to host machines in the host platform that they are running on. Using the links, a graph model can be displayed in a graphical user interface. The graph model can visually illustrate how the components in the Kubernetes cluster and the host cluster connect to each other.

References are made herein to Kubernetes. Kubernetes is an open-source container orchestration system for automating software deployment, scaling, and management. References to Kubernetes are merely exemplary and are not intended to be limiting in any way. For example, Kubernetes can encompass any container orchestration system, such as OPENSHIFT, HASICORP NOMAD, and RANCHER.

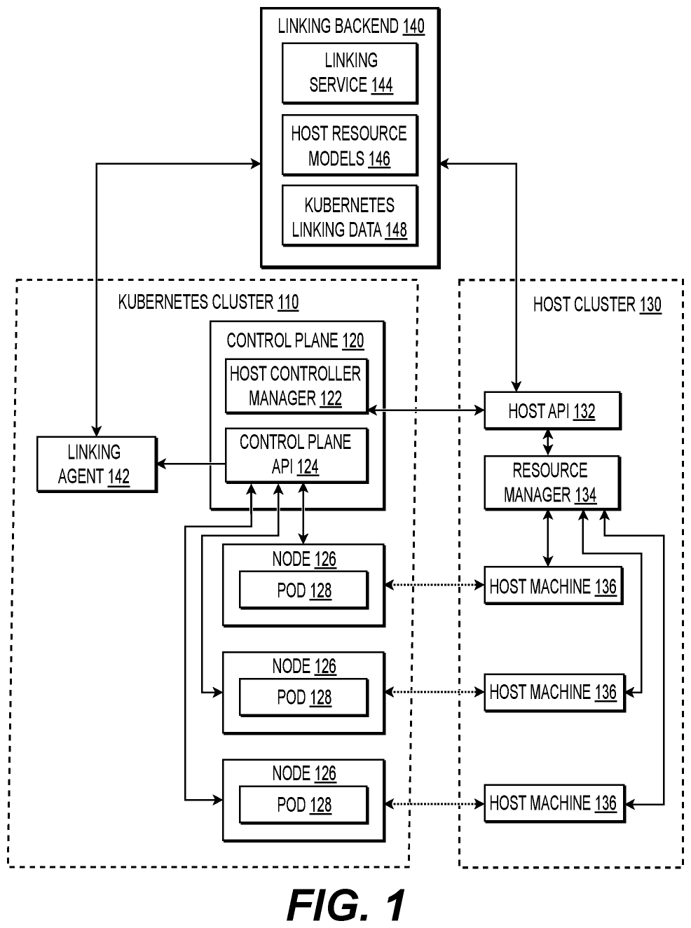

FIG. 1 is an illustration of an example system for linking Kubernetes resources with underlying infrastructure. Kubernetes systems deploy containerized applications on top of a host platform using a cluster-based architecture. For example, the example system of FIG. 1 illustrates a Kubernetes cluster 110 (also referred to herein interchangeably as “the cluster 110”) deployed on a host cluster 130. The host cluster 130 can be a computing cluster on any computing platform capable of hosting the Kubernetes cluster 110. For example, the host cluster 130 can be part of a cloud computing system or a computing device outside of that environment, such as one or more servers. Some examples of cloud computing systems that can include AMAZON WEB SERVICES (“AWS”), MICROSOFT AZURE, and GOOGLE CLOUD PLATFORM. Some host platforms can include multiple host clusters 130. The methods described later herein explain how Kubernetes clusters 110 can be matched up to their corresponding host clusters 130.

The Kubernetes cluster 110 includes of a set of nodes 126 that run containerized applications in pods 128. The nodes 126 can be virtual or physical machines, and every Kubernetes cluster has at least one node 126. The nodes 126 contain the services necessary to run pods 128. A pod 128 is a group of one or more containers, with shared storage and network resources, and a specification for how to run the containers. In other words, a pod 128 represents an instance of a containerized application. In cloud contexts, pods 128 model an application-specific “logical host.” In other words, pods 128 contains one or more application containers which are relatively tightly coupled. In non-cloud contexts, applications executed on the same physical or virtual machine are analogous to cloud applications executed on the same logical host.

A control plane 120 manages the nodes 126 and pods 128 in the cluster 110. A control plane Application Programming Interface (“API”) 124 (also referred to herein interchangeably as “Kubernetes API 124”) can execute on the front-end of the control plane 120. The Kubernetes API 124 can let end users, different components of the cluster 110, and external components communicate with one another. The Kubernetes API 124 can allow internal components of the cluster 110 to query and manipulate the state of API objects in the Kubernetes cluster 110. For example, the control plane 120 can include various controller processes (not shown) that can query and manipulate the state of the nodes 124 and pods 126. As some examples, a node controller can be responsible for detecting when nodes go down and executing an appropriate response, a job controller can watch for job objects that represent one-off tasks and then creates pods to run those tasks to completion, an endpoint controller can populate endpoint objects, and a service account and token controller can create default accounts and API access tokens for new namespaces. Populating endpoint objects can include joining a service with a pod 128. A service can be an abstract way to expose an application running on a set of pods 128 as a network service. For example, each pod 128 can be given its own Internet Protocol (“IP”) address and each set of pods 128 can be given a single Domain Name System (“DNS”) name. The control plane 120 can load balance traffic across pods 128 so that an end user is unaware of which pod 128 is being used. The Kubernetes API 124 can also allow end users and external computing devices or systems to query and manipulate the state of API objects in the Kubernetes cluster 110 by sending instructions in an API call to the Kubernetes API 124.

Each node 126 can run on an underlying host machine 136 from the host cluster 130. A host machine 136 can be any machine, virtual or physical, capable of running a node 126. For example, the host machines 136 can be a server or other computing device, or a virtual machine (“VM”) hosted in a cloud infrastructure.

In cloud-contexts (i.e., when the host cluster 130 is in a cloud platform), the control plane 120 can include a host controller manager 122 that includes control logic for linking the Kubernetes cluster 110 to a host API 132 of the host cluster 130. The cloud controller manager 122 can separate out the Kubernetes components that interact with the host cluster 130 from components that only interact with internal components of the cluster 130. For example, nodes 126 and pods 128 may interact with the host cluster 130, but not the control plane 120 processes that manage them.

A resource manager 134 at the host cluster 130 can manage the host machines 136 according to data received at the host API 132. For example, in a cloud-context, when a node 136 is added or removed, the control plane 120 can notify the host cluster 130 by sending an API call to the host API 132. The resource manager 134 can then create or delete a corresponding VM host machine 134. When a new VM host machine 134 is created for a new node 126, the resource manager 134 can send information about the new VM host machine 136 to the control plane 120, and the control plane 120 can use that information to begin managing the node 126 and its corresponding pod 128.

A linking backend 140 is introduced for linking nodes 126 to their corresponding host machines 136 and generating a graph model of these links. The linking backend 140 can be a service or group of services that run in the background. The linking backend 140 can execute on one or more servers, including executing virtually across multiple computing platforms or on a cloud-based computing platform. A linking agent 142 can run inside the Kubernetes cluster 110 and detect changes in any components of the Kubernetes cluster 110. For example, the linking agent 142 can make API calls to the control plane API 124 requesting any data relating to changes to components in the Kubernetes cluster. As an example, the linking agent 142 can request audit logs of components of the Kubernetes cluster 110, and the audit logs can indicate changes a components, such as when a component is created, modified, or deleted. In another example, the linking agent 142 can request specific information based on a template.

The linking agent 142 can be preconfigured with certain information not provided by the Kubernetes cluster 110. This information can help the linking backend 140 in creating links with the corresponding cloud components. For example, in a cloud-context, the Kubernetes cluster 110 can be installed in a certain geographic region of a cloud provider, and the cluster 110 can be associated with an account, such as the account of a specific client. The linking backend 140 can handle linking from Kubernetes clusters across multiple cloud providers, in multiple geographic regions, and for multiple accounts. The Kubernetes clusters may not be aware of such information. The linking agent 142 running in each Kubernetes cluster 110 can insert the additional information so that the linking backend 140 can distinguish the data being received and map it to the correct cloud platform data. For example, the linking agent 142 can insert a cloud provider identifier (“ID”), a geographic ID, an account ID, and so on. The additional information can indicate to the linking backend 140 whether the data being received is from a cluster 110 running at a data center or on a cloud, which cloud provider is hosting the cluster 110, where the cluster 110 is running, and what account the cluster 110 belongs to.

The linking backend 140 can include a linking service 144 that links the data from the linking agent 142 to data from the underlying host platform. For example, the linking backend 140 can include host resource models 146 that are models of host clusters 130. For example, the host resource models 146 can indicate which host machines 134 and other components are running on a host cluster 130 and how they interact with each other. The host resource models 146 can include information about the host machines 134, such as services and applications running on the host machines 134, security settings, network protocols, and so on. The linking service 144 can obtain the data for the host resource models 146 from the host platforms 130. For example, the linking service 144 can make an API call to the host platform's host API 132 to retrieve the data. The linking service 144, or another service, can then create the host resource models 146.

The linking service 144 can link the data from the Kubernetes cluster 110 to the host resource models 146 using methods described later herein. In one example, the linking service 144 can save the linked data as Kubernetes linking data 148. The host resource models 146 and the Kubernetes linking data 148 can be stored in one or more databases, such as a database server.

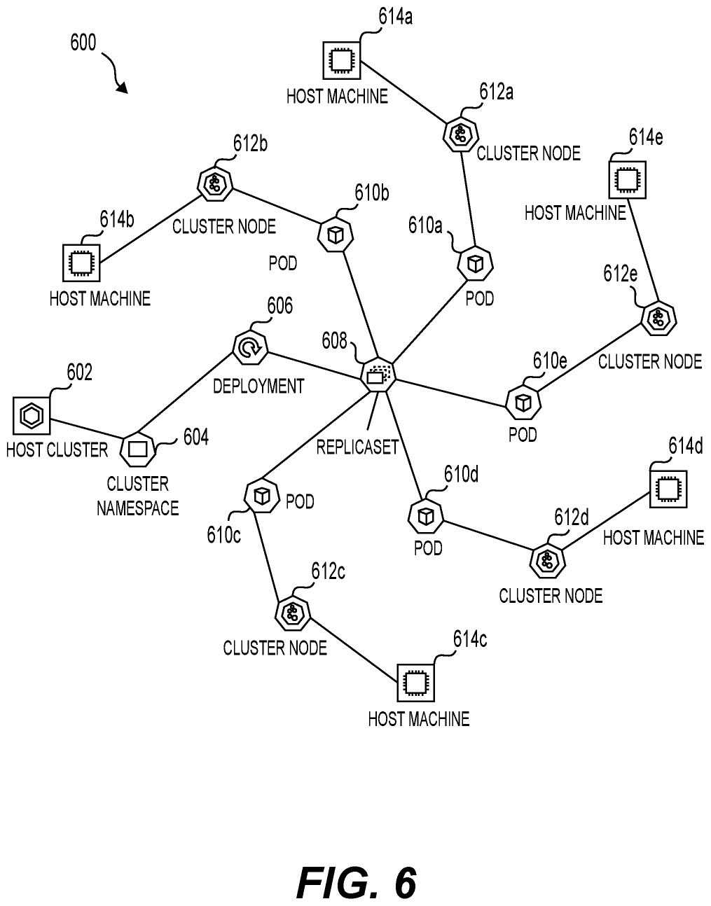

The Kubernetes linking data 148 can be used to generate a graph model that visually illustrates how the components of the Kubernetes cluster 110 link to each other and to their corresponding host machines 136. If a Kubernetes component is misconfigured or has a security flaw, a user can use the graph to identify which nodes 126, pods 128, and host machines 136 may be affected or vulnerable. An example of such a graph model is described later herein regarding FIG. 6.

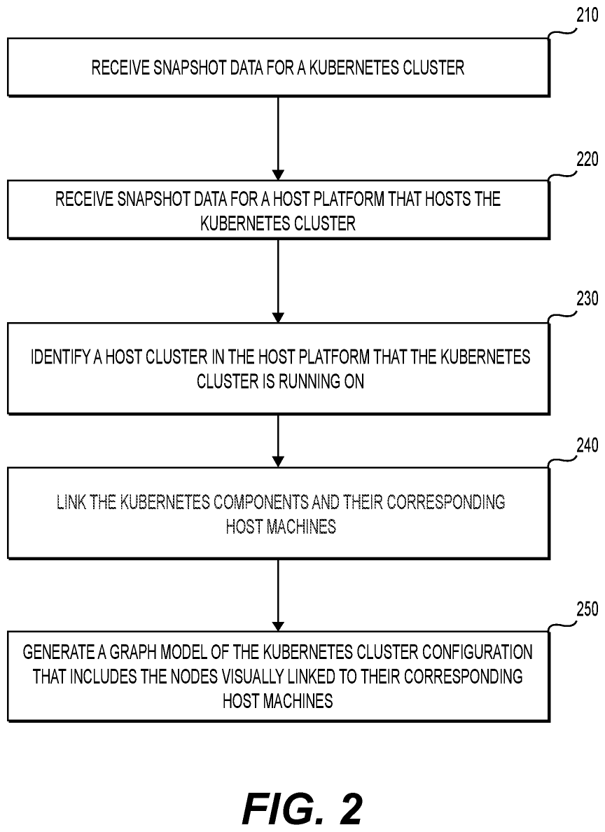

FIG. 2 is a flowchart of an example method for linking Kubernetes resources with underlying infrastructure. At stage 210, the linking service 144 can receive snapshot data for the Kubernetes cluster 110. The snapshot data from the Kubernetes cluster 110 (hereinafter referred to as “Kubernetes snapshot data”) can include data about the current state of the Kubernetes cluster 110. For example, the Kubernetes snapshot data can identify nodes 126 and pods 128 currently running in the Kubernetes cluster 110. The Kubernetes snapshot data can include the status of any other components included in the structure of the Kubernetes cluster 110, such as Deployments and ReplicaSets. A ReplicaSet is a Kubernetes component that maintains a stable set of replica pods 128 running at any given time. A Kubernetes Deployment provides declarative updates to ReplicaSets and pods 128.

The Kubernetes snapshot data can be received from the linking agent 142. For example, the linking agent 142 can retrieve the Kubernetes snapshot data by making an API call to the control plane API 124. The control plane API 124 can respond by sending a data file with the requested information, such as a JSON file or an XML, file. After receiving the Kubernetes snapshot data from the control plane API 124, the linking agent 142 can add information about the Kubernetes cluster 110. The added information can relate to characteristics of the host cluster 130 that the Kubernetes cluster 110 is running on. Examples of such information can include whether the cluster 110 is running in a data center or on a cloud platform, which cloud platform the cluster 110 is running on, the geographic location where the cluster 110 is running, account information for an account or client associated with the cluster 110, and a namespace associated with the cluster 110. The linking agent 142 can be preconfigured with this information or the linking agent 142 can be configured to obtain this information, depending on the example.

Kubernetes uses namespaces as a mechanism for isolating groups of components within a single cluster. Names of components need to be unique within a namespace, but not across namespaces. So, if a system has multiple Kubernetes clusters 110, then the Kubernetes snapshot data can include data relating to multiple components of the same type that have the same ID but are running in different clusters. So that the linking service 144 can distinguish between such components, the linking agent 142 running on each Kubernetes cluster 110 can add UIDs corresponding to a unique set of characteristics of the host cluster 130 that the Kubernetes cluster 110 is running on. For example, the linking agent 142 can add UIDs corresponding to the geographic region, host provider, account holder, namespace, and so on. The UIDs can be based on any combination of information that can uniquely identify the correct host cluster 130. In an example, the linking agent 142 can insert UIDs for each type of additional information. Each linking agent 142 running in a cluster 110 can be preconfigured with the UIDs of its associated Kubernetes cluster 110. Alternatively, the linking agents 144 can be configured to discover this information, such as by querying the associated control plane API 124 and host API 132.

At stage 220, the linking service 144 can receive snapshot data for the host cluster 130. The snapshot data from the host cluster 130 (hereinafter referred to as “host snapshot data”) can include data about the current state of the host cluster 130. The host snapshot data can include data relating to multiple host clusters 130. For example, the host machines 136 can be grouped into clusters based on the Kubernetes cluster 110 that they correspond to. The host snapshot data can identify the host machines 136 currently running in each host cluster 130, such as with a unique ID of each host machine 136. Each host machine's ID can be unique within the context of its cluster 130, such as when the host provider uses namespaces, or, alternatively, unique to the entire host platform, depending on how the host assigns IDs.

The host snapshot data can include additional information about the host platform components and their corresponding clusters. For example, similar to the Kubernetes snapshot data, the host snapshot data can include information about the cluster's geographic region, account, namespace, and so on. The linking service 144 can assign UIDs to each host components and clusters based on the additional information. The linking service 144 can use this additional information to match the host clusters 130 with their corresponding Kubernetes clusters 110, which is described later herein.

In some examples, the linking service 144 can receive host snapshot data from multiple host providers. For example, some Kubernetes clusters 110 can run on AWS, some on MICROSOFT AZURE, some on GOOGLE CLOUD PLATFORM, and some on a local datacenter. The linking service 144 can retrieve host snapshot data from all the host providers being used by making an API call to their corresponding host API 132. The host API 132 can respond by sending a data file with the requested information, such as a JAVASCRIPT Object Notation (“JSON”) file or an Extensible Markup Language (“XML”) file. The linking service 144 can add a UID of the corresponding host to the host snapshot data to aid in correctly linking the host machines 132 with their Kubernetes counterparts.

The linking service 144 can create a host resource model 146 from the host snapshot data. For example, the linking service 144 can be preconfigured with a database schema, and the linking service 144 can translate the host snapshot data according to the schema. Translating the host snapshot data with the database schema can put the host snapshot data into a format that can be used for generating a graph model of the host cluster 130 and make the host snapshot data ready for linking with the data from the Kubernetes cluster 110.

Although the Kubernetes snapshot data is described as being received before the host snapshot data, this is merely exemplary. For example, the linking service 144 can receive the host snapshot data before or at the same time as the Kubernetes snapshot data.

At stage 230, the linking service 144 can identify a host cluster 130 that is running the Kubernetes cluster 110. For example, the UIDs in the Kubernetes snapshot data can be mapped to characteristics for host clusters 130. The linking service 144 can identify the host cluster 130 with a combination of characteristics that match the UIDs included in the Kubernetes snapshot data. In one example, the linking service 144 can assign UIDs to the host snapshot data and simply match UID combinations.

At stage 240, the linking service 144 can link the Kubernetes components and their corresponding host machines 136. This linking can include linking Kubernetes clusters 110 to their corresponding host cluster 130. The linking can also include linking components within Kubernetes cluster 110 to each other as well as linking Kubernetes nodes 126 to their corresponding host machines 136. The Kubernetes clusters 110 can be linked to their corresponding host clusters 130 based on shared unique UID combinations.

In an example, the linking can be done by inserting data into a template for each component. The template can call for information that identifies the component, the component type, and identify other connected components. Different templates can be used for the various component types. Table 1 below includes an example JSON template.

```
TABLE 1
{
  “Template”: {
    “type”: [“pod”, “node”, “ReplicaSet”, “Deployment”, “instance”],
    “componentID”: [ ],
    “provider”: [“AWS”, “AZURE”, “GCP”, “Kubernetes”],
    “region”: [“us-north”, “us-south”, “us-east”, “us-west”],
    “clustername”: [ ],
    “uids”: [ ],
    “linkedcomponent1”: [ ],
    “linkedcomponent2”: [ ],
  }
}
```

In the example template format above, the “type” field corresponds to the component type where the available component types are listed. For example, “pod” can correspond to a Kubernetes pod 128, “node” can correspond to a Kubernetes node 126, “ReplicaSet” can correspond to a Kubernetes ReplicaSet, “Deployment” can correspond to a Kubernetes Deployment, and “instance” can correspond to a host machine 136. The “componentID” field can correspond to an ID specific to a component within its cluster 110. The “provider” field corresponds to the provider of the component. For example, the provider for Kubernetes components can be “Kubernetes,” and the provider for a host machine 136 can be the name of the host machine's cloud provider, such as AWS, MICROSOFT AZURE, or GOOGLE CLOUD PLATFORM. The “region” field can designate a geographic region of the cluster. The template includes a list of available regions that can be inserted into this field. However, these example regions are merely exemplary and not meant to be limiting in any way. The “clustername” field can correspond to a namespace associated with the cluster. The “uids” fields can correspond to the unique UID combination of the component.

The “linkedcomponent1” and “linkedcomponent2” can correspond to componentIDs of related components. For example, an entry for a host machine 136 can include a componentID of the node 126 it is hosting and the componentID of any other connected cloud components. An entry for a node 126 can include the componentID of its corresponding host machine 136 and the componentID for the pod 128 running on the node 126. An entry for a pod 128 can include the componentID of its corresponding node 126 and the componentID of its corresponding ReplicaSet. An entry for a ReplicaSet can include componentIDs for all associated pods 128 and the componentID of the Deployment component managing the ReplicaSet. Because a ReplicaSet can be connected to multiple pods 128, the linkedcomponent1 field can include the componentIDs, one for each connected pod 128.

In this example template, the linkedcomponent1 and linkedcomponent2 fields are where the deep linking can occur. For example, the linkedcomponent1 and linkedcomponent2 fields can include deep links to data entries for the related components. Deep links can include a hyperlink that links to a specific, generally searchable or indexed, piece of data. For example, each component in the host cluster 130 and the Kubernetes cluster 110 can have a data entry created from a template. The data entries for the host cluster 130 can be stored as the host resource models 146 and the data entries for the Kubernetes cluster 110 can be stored as the Kubernetes linking data 148. The host resource models 146 and Kubernetes linking data 148 can be stored as two different data tables. The data entries in both tables 416, 148 can have searchable addresses. When the linking service 144 creates the data entries for nodes 126 in the Kubernetes cluster 110, the linking service 144 can insert deep links that point to their corresponding host machines 136. In the example template in Table 1, the deep links can be inserted into the “linkedcomponent1” or “linkedcomponent2” field. Alternatively, the linkedcomponent1 and linkedcomponent2 can include an ID of the related components, and the linking service 144 can be configured to connect components in a graph model according to the IDs in those fields.

The linkedcomponent1 and linkedcomponent2 fields can indicate a direction of the linking. For example, a first component can match to other components with a linkedcomponent1 value matching the first component's linkedcomponent2 value in one direction. In another direction, the first component can link to other components with a linkedcomponent1 value matching the first component's linkedcomponent2 value. A component can match to multiple other components in a direction when multiple values match. For example, a ReplicaSet can match to a single Deployment in one direction, and in another direction can match to multiple pods 128.

At stage 250, the linking service 144 can generate a graph model of the Kubernetes cluster configuration. The graph model can also visually link internal components of the Kubernetes cluster 110. The graph model can be displayed in a GUI that a user can interact with for viewing and managing Kubernetes clusters 110. The linking backend 140 can include a web server that hosts an application, and the GUI can be a front-end interface of the application. The user can access the application through a web browser. Alternatively, the application as a whole, the GUI, or other components of the application may be installed directly on a user's device. Actions described herein as being performed by the GUI can be performed by the corresponding application or service rather than the GUI itself

The graph model can visually illustrate links between Kubernetes and host platform components as a node graph that includes nodes and edges. Nodes in the graph (hereinafter referred to as “graph nodes”) can represent a component, such as a pod 128, node 126, or host machine 136. Edges drawn between graph nodes can represent a link between the corresponding components.

Moving to FIG. 6, an example graph model 600 is illustrated. The graph model 600 includes the components of a single Kubernetes cluster 110. The components are represented by the various graph nodes, and edges connecting the graph nodes illustrate a link between corresponding components. For example, a cluster node 602 is a graph node that represents a host cluster 130 from the host platform that the displayed Kubernetes cluster 110 belongs to. The cluster node 602 is connected to a namespace node 604 by an edge. The namespace node 604 represents the namespace of the Kubernetes cluster 110. The namespace node 604 connects to a Deployment node 606, which represents a Kubernetes Deployment in the cluster 110. The Deployment node connects to a ReplicaSet node 608 representing a ReplicaSet in the cluster 110. The ReplicaSet node 608 connects to pod nodes 610a, b, c, d, and e that each represent a pod 128 managed by the ReplicaSet. Each of the pod nodes 610a-e connects to a corresponding Kubernetes node 612a, b, c, d, and e, respectively. The Kubernetes nodes 612a-e represent nodes 126 that the pods 128 run on. Each of the Kubernetes nodes 612a-e connects to a corresponding host machine node 614a, b, c, d, and e, respectively. The host machine nodes 614a-e represent host machines 136 that host their corresponding nodes 126. The graph nodes can include information about the corresponding component. Such information can include, for example, a component's UIDs, geographic region, account ID, provider, component type, associated namespace, and so on. A user can view this information by selecting a graph node or hovering a mouse indicator over a graph node, for example.

The edges can be determined based on links created by the linking service 144. Using the template from Table 1 as an example, the ReplicaSet node 608 can include linkedcomponent2 values corresponding to all the pod nodes 610a-e, and the pod nodes 610a-e can include a linkedcomponent1 value corresponding to the ReplicaSet node 608. Based on these shared values, the graph model 600 includes edges between the ReplicaSet 608 and the pod nodes 610a-e. Similarly, the pod nodes 610a-e can include a linkedcomponent2 corresponding to their corresponding Kubernetes nodes 612a-e, and the Kubernetes nodes can include a linkedcomponent1 value corresponding to their corresponding pod nodes 610a-e. Based on these shared values, the graph model 600 includes edges between each pod node 610a-e and its corresponding Kubernetes node 612a-e. The graph model 600 includes edges between the Kubernetes nodes 612a-e and their corresponding host machine nodes 614a-e based on the same logic.

In one example, performing a predefined selection type on a graph node, such as a long press or double-click, can cause the graph model 600 to rearrange so that the selected graph node is the center point of the graph. For example, the center point of the graph model 600 illustrated in FIG. 6 is the ReplicaSet node 608. For this reason, the other graph nodes displayed are the graph nodes linked to the ReplicaSet node 608. However, Kubernetes Workloads can manage multiple ReplicaSets, multiple Deployments can be included in a Kubernetes namespace, and multiple namespaces can be included in a host cluster. Selecting the Deployment node 606 can cause the graph model 600 to display graph nodes for all the ReplicaSets managed by the Kubernetes Deployment. Selecting the namespace node 604 can cause the graph model 600 to display graph nodes for all the Workloads within the namespace. Selecting the cluster node 602 can cause the graph model 600 to display graph nodes for all the namespaces within the host cluster. When a graph node is selected with this predetermined selection type, the graph model 600 can display neighboring components based on the linking that occurs at stage 230.

The links can allow a user to navigate across a Kubernetes cluster 110 or into other clusters from within the GUI. If any component in a cluster 110 is misconfigured or poses a security risk, a user can select the component and the graph model 600 can display all the connected components in both the Kubernetes cluster 110 and on the host cluster 130 that may be at risk. The user can also quickly navigate into other namespaces and clusters when the risk may reach outside the Kubernetes cluster 110.

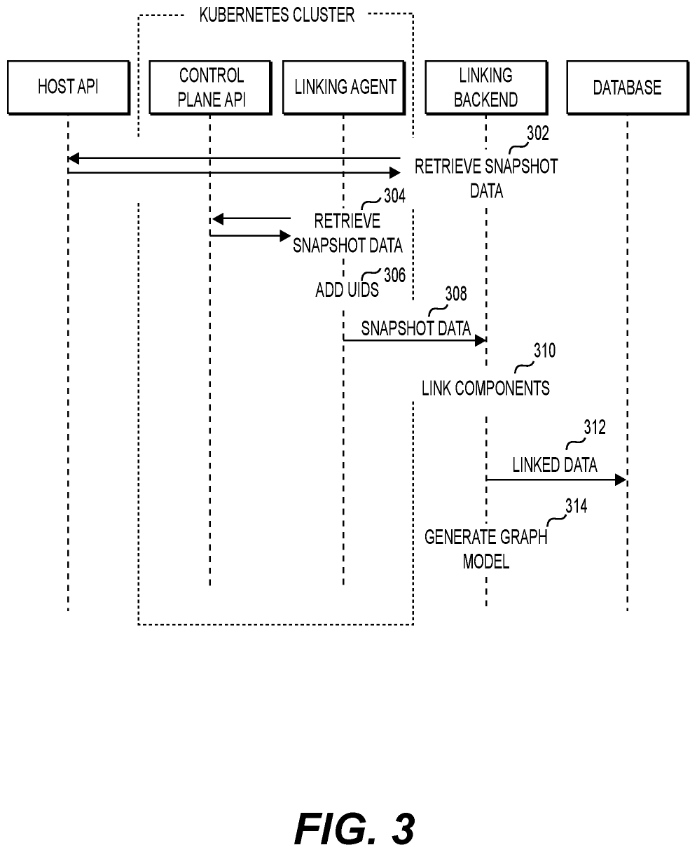

FIG. 3 is a sequence diagram of an example method for linking Kubernetes resources with underlying infrastructure. At stage 302, the linking service 144 can retrieve host snapshot data from the host API 132. The host snapshot data can include data about the current state of the host cluster 130. For example, the host snapshot data can include information about host machines 136, any clusters the host machines 136 belong to, the geographic location where each host machine 136 is running, an account associated with each host machine 136, a namespace associated with each host machine 136, and so on.

The linking service 144 can retrieve the host snapshot data by making an API call to the host API 132. The host API 132 can respond by sending a data file, such as a JSON or XML file, that includes the host snapshot data.

At stage 304, the linking agent 142 can retrieve snapshot data from the Kubernetes API. The Kubernetes snapshot data can include data about the current state of the Kubernetes cluster 110. For example, the Kubernetes snapshot data can include information about nodes 126, pods 128, and any other Kubernetes components. The linking agent 142 can retrieve the Kubernetes snapshot data by making an API call to the control plane API 124. The control plane API 124 can respond by sending a data file, such as a JSON or XML file, that includes the Kubernetes snapshot data.

At stage 306, the linking agent 142 can add UIDs to the Kubernetes snapshot data. For example, a linking agent 142 can run on each Kubernetes cluster 110 for an entity or account. Each linking agent 142 can be preconfigured with UIDs corresponding to various aspects of its corresponding cluster 110. For example, each linking agent 142 can be preconfigured with UIDs corresponding to the cluster's geographic location, associated account holder, namespace, and so on. The linking agent 142 can add the UIDs to any Kubernetes snapshot data it sends to the linking service 144 so that the linking service 144 can associate the Kubernetes snapshot data with its corresponding host snapshot data.

At stage 308, the linking agent 142 can send the Kubernetes snapshot data to the linking service 144. For example, the linking agent 142 can send a data file, such as a JSON or XML file, with the Kubernetes snapshot data, including the UIDs. The linking agent 142 can send the Kubernetes snapshot data using any appropriate communication protocol, such as an API call or a Hypertext Transfer Protocol Secure (“HTTPS”) call.

At stage 310, the linking service 144 of the linking backend 140 can link the host cluster 130 and Kubernetes cluster 110 components. Part of the linking can include matching the Kubernetes cluster 110 to the correct host cluster 130 using the UID combinations. For example, the linking service 144 can organize the host snapshot data into clusters based on shared characteristics of components, such as the geographic region, account ID, namespace, running applications, and so on. The linking service 144 can assign UIDs to the host clusters based on the characteristics. The linking service 144 can then match the Kubernetes snapshot data to the host cluster with the same UID combination.

After the Kubernetes snapshot data and host snapshot data have been matched, the linking service 144 can link components in the clusters. For example, Deployments can be linked to ReplicaSets, ReplicaSets can be linked to pods 128 they are managing, pods 128 can be linked to their corresponding nodes 126, and nodes 126 can be linked to the host machines 136 they are running on. The Kubernetes and host platform components can be linked by translating the Kubernetes and host snapshot data according to a database schema. For example, the linking agent 142 can create an entry in a database for each component using a template, such as the template in Table 1.

At stage 312, the linking service 144 can store the linked data at a database. The database can be any kind of data storage, such as a database server.

At stage 314, the linking service 144 can generate a graph model using the translated snapshot data. The graph model can be displayed in a GUI on a user device. For example, a user can select the Kubernetes cluster 110 in the GUI, and the GUI can display a graph model of the selected cluster 110. The graph model can include graph nodes representing the various components of the Kubernetes cluster 110 and host cluster 130, and the graph nodes can be interconnected with edges based on the links created previously. An example of such a graph model is described previously regarding FIG. 6.

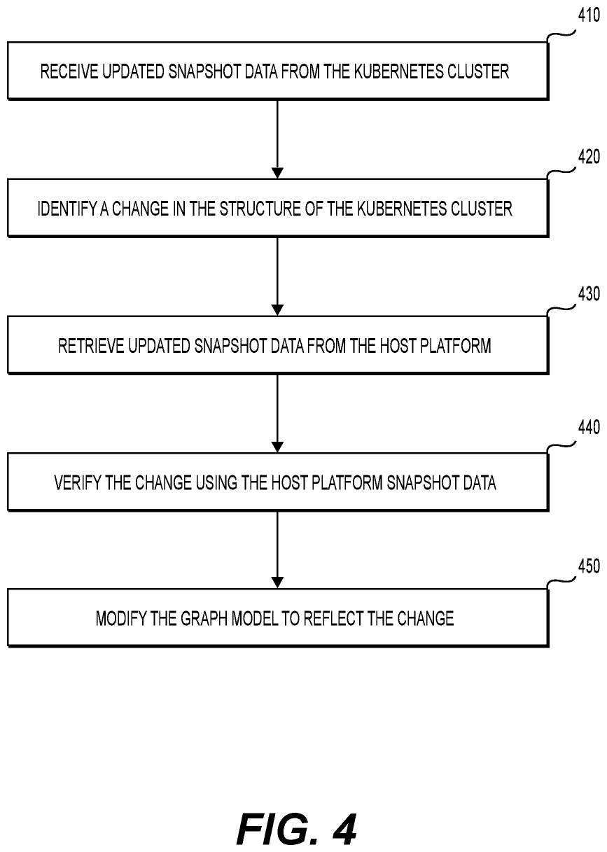

FIG. 4 is a flowchart of an example method for updating links of Kubernetes resources with their underlying infrastructure. This example method can occur, for example, after components of the Kubernetes cluster 110 have been linked with their underlying infrastructure in the host cluster 130 using the methods described previously.

At stage 410, the linking service 144 can receive updated Kubernetes snapshot data. The updated Kubernetes snapshot data can be received from the linking agent 142. For example, the linking agent 142 can send an API call to the control plane API 124, and the control plane API 124 can respond by providing a data file with the updated Kubernetes snapshot data. The data file can be in any appropriate format, such as a JSON or XML, data file. The linking agent can add UIDs to the updated Kubernetes snapshot data based on the cluster 110 that the linking agent 142 is running in. The UIDs can correspond to certain characteristics of the cluster 110, such as the geographic region, provider, account holder, namespace, and so on. The linking agent 142 can then send the data file with the updated Kubernetes snapshot data to the linking service 144.

At stage 420, the linking service 144 can identify a change in the structure of the Kubernetes cluster 110. A structural change to the Kubernetes cluster 110 can include any component being added, removed, or edited. For example, a ReplicaSet can dynamically add or remove pods 128 based on demand for their associated applications. In one example, the linking service 144 can identify the change by comparing the updated Kubernetes snapshot data to the Kubernetes linking data 148 previously stored. For example, the updated Kubernetes snapshot data can include data on the entirety of the cluster 110. The linking service 144 can translate the updated Kubernetes snapshot data according to the database schema and identify differences between the Kubernetes linking data 148 and the updated Kubernetes snapshot data. Alternatively, the linking agent 142 can leverage logs created by the control plane 120. For example, Kubernetes control planes 120 can create logs of events that occur within the cluster 110, such as a node 126 or pod 128 being added, removed, or modified. The linking agent 142 can retrieve the update logs by querying the control plane API 124. The linking agent 142 can be configured to identify logs for any structural changes. When the linking agent 142 identifies such a log, the linking agent 142 can add the UIDs and send the logs to the linking service 144.

At stage 430, the linking service 144 can retrieve updated host snapshot data from the host cluster 130. The updated host snapshot data can be specific to the component(s) that changed according to the updated Kubernetes snapshot data. For example, the linking service 144 can query the host API 132 of the corresponding host, and the query can include a request for the status of the changed component(s). The host API 132 can respond by sending a datafile, such as a JSON or XML file, with requested information.

At stage 440, the linking service 144 can verify the change using the updated host snapshot data. The way the verification occurs can depend on the type of change. For example, if a pod 128 and its corresponding node 126 are removed from the Kubernetes cluster 110, then the linking service 144 can identify the corresponding host machine 136 using the Kubernetes linking data 148. The linking service 144 can request the status of the host machine 136, and the host API 132 can respond with a message indicating that the host machine 136 does not exist. This is because a host machine 136 is decommissioned when the corresponding node 136 is removed from the cluster 110.

If a new node 126 is added to the cluster 110, then the linking service 144 can request information relating to a new host machine 136 that is running the new node 126. If the host cluster 130 is configured with the IDs of nodes 126 in the cluster 110, then the linking service can make an API call to the host API 132 requesting information related to the new node 126, and the host API 132 can respond with a data file that includes information about the corresponding host machine 136. Alternatively, the Kubernetes cluster 110 can retain the IDs of corresponding host machines 136, and the linking service 144 can query information using the new host machine's ID. The linking service 144 can then update the host resource models 146 and Kubernetes linking data 148 by adding data related to the components. This can include creating new links for the new components.

At stage 450, the linking service 144 can modify the graph model to reflect the change. For example, if a component is removed from the cluster 110, then the linking service 144 can remove any data in the host resource models 146 and Kubernetes linking data 148 relating to the removed components. In a component is added, then the linking service 144 can add new entries for the added components in the host resource models 146 and Kubernetes linking data 148. In an example, the entries can be created from a template, such as the template illustrated in Table 1. The linking service 144 can also create new links for the new components. Because data from the host resource models 146 and Kubernetes linking data 148 are used to generate the graph model, the updates can cause the graph model to automatically update the next time the graph model is accessed or refreshed.

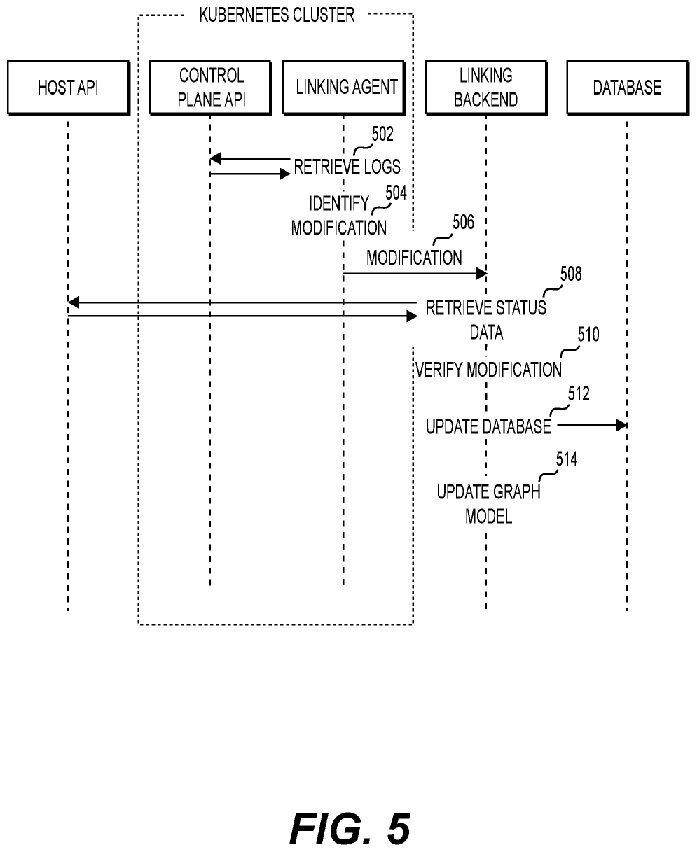

FIG. 5 is another sequence diagram of an example method for updating links of Kubernetes resources with their underlying infrastructure. At stage 502, the linking agent 142 can retrieve logs from the control plane API 124. For example, the linking agent 142 can send an API call to the control plane API 124, and the control plane API 124 can respond with a data file that includes logs created for events that occurred at the cluster 110. The linking agent 142 can be configured to retrieve the logs periodically, such as every hour or every day at a certain time. The API call can specify a time frame for the logs. For example, the linking agent 142 can request logs that have been created since the time the linking agent 142 last made the request.

At stage 504, the linking agent 142 can identify a modification to a resource in the Kubernetes cluster. For example, the linking agent 142 can be configured to identify logs for any modifications to the cluster 110. When the linking agent 142 identifies such a log, the linking agent 142 can add the UIDs for the cluster 110, and, at stage 506, send the logs to the linking service 144.

At stage 508, the linking service 144 can retrieve status data about the modified resource from the host API 132. This can be done using an API call that requests status information on the modified resource. The host API 132 can respond by sending a data file with the requested information.

At stage 510, the linking service 144 can verify the modification. For example, if a Kubernetes component was removed, then the linking service 144 can request information about the corresponding host machine 136. A response from the host API 132 indicating that the host machine 136 does not exist can verify that the component was removed. If a component was added, then the linking service 144 can request information about a new host machine 136 added for the cluster. A response from the host API 132 that includes information about the new host machine 136 can verify that the Kubernetes component was added.

If a modification cannot be verified, the linking service 144 can notify an admin user, such as by sending a message, notification, or email. This can occur, for example, if a node 126 is removed but the host machine 136 is still running, or if a node 126 is added but there is no corresponding host machine 136 at the host platform. The admin user can then investigate and make any necessary changes to the cluster 110 or the host cluster 130.

At stage 512, the linking service 144 can update the database. This can include updating the host resource models 146 and Kubernetes linking data 148. For example, if a component is removed to the cluster 110, then the linking service 144 can remove any data in the host resource models 146 and Kubernetes linking data 148 relating to the removed components. If a component is added, then the linking service 144 can add new entries for the added components in the host resource models 146 and Kubernetes linking data 148. In an example, the entries can be created from a template, such as the template illustrated in Table 1. The linking service 144 can also create new links for the new components.

At stage 514, the linking service 144 can modify the graph model. Modifying the graph model can occur automatically in response to the updates made at stage 512. For example, the next time a user accesses or refreshes the graph model for the cluster 110 from the GUI, the updated host resource models 146 and Kubernetes linking data 148 can be retrieved for generating the graph model.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for linking Kubernetes resources with underlying infrastructure, comprising:
receiving host snapshot data that includes data relating to a plurality of host clusters running on a host platform, host machines running on the plurality of host clusters, and characteristics specific to each of a plurality of host clusters;
receiving, from an agent executing in a Kubernetes cluster, snapshot data for the Kubernetes cluster, the Kubernetes snapshot data including a configuration of components in the Kubernetes cluster and universal identifiers (“UIDs”) associated with the Kubernetes cluster, wherein each UID corresponds to a characteristic;
identifying a host cluster of the plurality of host clusters that the Kubernetes cluster is running on based on the UIDs matching to the host cluster's characteristics;
linking components of the Kubernetes cluster with corresponding host machines in the host cluster using the host snapshot data and the Kubernetes snapshot data; and
generating, using the links, a graph model of the Kubernetes cluster configuration that includes each of a plurality of Kubernetes nodes visually linked to their corresponding host machines.

2. The method of claim 1, wherein the Kubernetes snapshot data includes an identifier (“ID”) of a third-party provider of the host platform, an account ID, a Kubernetes namespace, and a geographic region of the host machines, and wherein the third-party provider ID, account ID, namespace and geographic region are used to link the components of the Kubernetes cluster with their corresponding host machines.

3. The method of claim 2, wherein the third-party provider ID, account ID, namespace, and geographic region are added as UIDs to the Kubernetes snapshot data by the agent.

4. The method of claim 1, further comprising:
receiving updated Kubernetes cluster snapshot data from the Kubernetes cluster;
identifying a change in the Kubernetes cluster;
retrieving updated host platform snapshot data from the host platform;
verifying the change using the host platform snapshot data; and
modifying the graph model to reflect the change.

5. The method of claim 4, wherein:
identifying the change includes determining that a new node was added to the Kubernetes cluster,
retrieving updated host platform snapshot data includes extracting a new UID associated with the new node and requesting a status of a host machine with the new UID from the host platform, and
verifying the change includes receiving a response from the host platform that includes status information of the host machine with the new UID.

6. The method of claim 4, wherein:
identifying the change includes determining that a node was removed from the Kubernetes cluster,
retrieving updated host platform snapshot data includes requesting, from the host platform, a status of a host machine running the removed Kubernetes cluster, and
verifying the change includes receiving a response from the host platform indicating that host machine running the removed Kubernetes cluster does not exist.

7. The method of claim 1, wherein linking components of the Kubernetes cluster with corresponding host machines includes creating a data entry for each of the plurality of Kubernetes nodes in a first data table, the data entries including a deep link that points to a data entry for a corresponding host machine in a second data table.

8. A non-transitory, computer-readable medium containing instructions that, when executed by a hardware-based processor, causes the processor to perform stages for linking Kubernetes resources with underlying infrastructure, the stages comprising:
receiving host snapshot data that includes data relating to a plurality of host clusters running on a host platform, host machines running on the plurality of host clusters, and characteristics specific to each of a plurality of host clusters;
receiving, from an agent executing in a Kubernetes cluster, snapshot data for the Kubernetes cluster, the Kubernetes snapshot data including a configuration of components in the Kubernetes cluster and universal identifiers (“UIDs”) associated with the Kubernetes cluster, wherein each UID corresponds to a characteristic;
identifying a host cluster of the plurality of host clusters that the Kubernetes cluster is running on based on the UIDs matching to the host cluster's characteristics;
linking components of the Kubernetes cluster with corresponding host machines in the host cluster using the host snapshot data and the Kubernetes snapshot data; and
generating, using the links, a graph model of the Kubernetes cluster configuration that includes each of a plurality of Kubernetes nodes visually linked to their corresponding host machines.

9. The non-transitory, computer-readable medium of claim 8, wherein the Kubernetes snapshot data includes an identifier (“ID”) of a third-party provider of the host platform, an account ID, a Kubernetes namespace, and a geographic region of the host machines, and wherein the third-party provider ID, account ID, namespace and geographic region are used to link the components of the Kubernetes cluster with their corresponding host machines.

10. The non-transitory, computer-readable medium of claim 9, wherein the third-party provider ID, account ID, namespace, and geographic region are added as UIDs to the Kubernetes snapshot data by the agent.

11. The non-transitory, computer-readable medium of claim 8, the stages further comprising:
receiving updated Kubernetes cluster snapshot data from the Kubernetes cluster;
identifying a change in the Kubernetes cluster;
retrieving updated host platform snapshot data from the host platform;
verifying the change using the host platform snapshot data; and
modifying the graph model to reflect the change.

12. The non-transitory, computer-readable medium of claim 11, wherein
identifying the change includes determining that a new node was added to the Kubernetes cluster,
retrieving updated host platform snapshot data includes extracting a new UID associated with the new node and requesting a status of a host machine with the new UID from the host platform, and
verifying the change includes receiving a response from the host platform that includes status information of the host machine with the new UID.

13. The non-transitory, computer-readable medium of claim 11, wherein
identifying the change includes determining that a node was removed from the Kubernetes cluster,
retrieving updated host platform snapshot data includes requesting, from the host platform, a status of a host machine running the removed Kubernetes cluster, and
verifying the change includes receiving a response from the host platform indicating that host machine running the removed Kubernetes cluster does not exist.

14. The non-transitory, computer-readable medium of claim 8, wherein linking components of the Kubernetes cluster with corresponding host machines includes creating a data entry for each of the plurality of Kubernetes nodes in a first data table, the data entries including a deep link that points to a data entry for a corresponding host machine in a second data table.

15. A system for linking Kubernetes resources with underlying infrastructure, comprising:
a memory storage including a non-transitory, computer-readable medium comprising instructions; and
a hardware-based processor that executes the instructions to carry out stages comprising:
receiving host snapshot data that includes data relating to a plurality of host clusters running on a host platform, host machines running on the plurality of host clusters, and characteristics specific to each of a plurality of host clusters;
receiving, from an agent executing in a Kubernetes cluster, snapshot data for the Kubernetes cluster, the Kubernetes snapshot data including a configuration of components in the Kubernetes cluster and universal identifiers (“UIDs”) associated with the Kubernetes cluster, wherein each UID corresponds to a characteristic;
identifying a host cluster of the plurality of host clusters that the Kubernetes cluster is running on based on the UIDs matching to the host cluster's characteristics;
linking components of the Kubernetes cluster with corresponding host machines in the host cluster using the host snapshot data and the Kubernetes snapshot data; and
generating, using the links, a graph model of the Kubernetes cluster configuration that includes each of a plurality of Kubernetes nodes visually linked to their corresponding host machines.

16. The system of claim 15, wherein the Kubernetes snapshot data includes an identifier (“ID”) of a third-party provider of the host platform, an account ID, a Kubernetes namespace, and a geographic region of the host machines, and wherein the third-party provider ID, account ID, namespace and geographic region are used to link the components of the Kubernetes cluster with their corresponding host machines.

17. The system of claim 16, wherein the third-party provider ID, account ID, namespace, and geographic region are added as UIDs to the Kubernetes snapshot data by the agent.

18. The system of claim 15, the stages further comprising:
receiving updated Kubernetes cluster snapshot data from the Kubernetes cluster;
identifying a change in the Kubernetes cluster;
retrieving updated host platform snapshot data from the host platform;
verifying the change using the host platform snapshot data; and
modifying the graph model to reflect the change.

19. The system of claim 18, wherein
identifying the change includes determining that a new node was added to the Kubernetes cluster,
retrieving updated host platform snapshot data includes extracting a new UID associated with the new node and requesting a status of a host machine with the new UID from the host platform, and
verifying the change includes receiving a response from the host platform that includes status information of the host machine with the new UID.

20. The system of claim 18, wherein
identifying the change includes determining that a node was removed from the Kubernetes cluster,
retrieving updated host platform snapshot data includes requesting, from the host platform, a status of a host machine running the removed Kubernetes cluster, and
verifying the change includes receiving a response from the host platform indicating that host machine running the removed Kubernetes cluster does not exist.
